(19) United States
(12) Patent Application Publication
(10) Pub. No.: US 2023/0139180 A1
(43) Pub. Date: May 4, 2023

(54) DRIVE APPARATUS

(71) Applicant: NIDEC CORPORATION, Kyoto (JP)

(72) Inventors: Yuki ISHIKAWA, Kyoto (JP); Hitoshi KUROYANAGI, Kyoto (JP); Keisuke NAKATA, Kyoto (JP)

(21) Appl. No.: 17/969,688

(22) Filed: Oct. 20, 2022

(30) Foreign Application Priority Data
Oct. 29, 2021 (JP) 2021-177846

(51) Int. Cl. H02K 9/19; H02K 5/20

(52) U.S. Cl. CPC H02K 9/19; H02K 5/20

(57) ABSTRACT

A drive apparatus includes a motor, a transmission, an inverter, a housing accommodating the motor, transmission, inverter, and a fluid, a refrigerant for the inverter, a pump for the fluid, and a cooler that exchanges heat between the fluid and refrigerant. The housing includes first-third portions accommodating the motor, transmission and inverter, respectively, and a support portion. The second portion is on one side of the first portion in an axial direction. The support portion is radially outside in a circumferential direction, and is connected to an outer peripheral portion of the first portion and a bottom portion of the third portion. The support portion supports the pump and the cooler. Any one of the pump and the cooler is disposed on one side in the circumferential direction with respect to the support portion, and the other is disposed radially outside with respect to the support portion.

### CROSS-REFERENCE TO RELATED APPLICATIONS

The present invention claims priority under 35 U.S.C. § 119 to Japanese Patent Application No. 2021-177846 filed on Oct. 29, 2021, the entire content of which is incorporated herein by reference.

### FIELD OF THE INVENTION

The present invention relates to a drive apparatus.

### BACKGROUND

In the related art, a drive apparatus is mounted on an electric vehicle or the like. A cooling structure for cooling a rotary electric machine is mounted on such a drive apparatus. Conventionally, a structure is known in which a refrigerant is cooled by a cooling device (cooler) provided outside a motor (rotary electric machine), and is supplied to the motor by a pump provided outside the motor.

An inverter, a reduction gear, and the like are attached to the drive apparatus described above. Such a drive apparatus has a problem that a dead space is likely to be generated when the drive apparatus is mounted on a vehicle, because of a complex outer shape thereof.

### SUMMARY

One aspect of an exemplary drive apparatus of the present invention includes a motor that includes a rotor rotating about a motor axis and a stator surrounding the rotor, a transmission mechanism that includes a plurality of gears and transmits a power of the motor, an inverter that controls a current to be supplied to the motor, a housing that houses the motor, the transmission mechanism, and the inverter, a fluid that is housed within the housing, a flow path through which the fluid flows, a refrigerant that cools at least the inverter, a refrigerant flow path through which the refrigerant flows, a pump that pumps the fluid within the flow path, and a cooler that exchanges heat between the fluid and the refrigerant. The housing includes a motor housing portion that houses the motor, a transmission mechanism housing portion that is located on one side of the motor housing portion in an axial direction to house the transmission mechanism, an inverter housing portion that houses the inverter, and a support portion that is located radially outside the motor housing portion and one side of the inverter housing portion in a circumferential direction when viewed from the axial direction, and is connected to an outer peripheral portion of the motor housing portion and a bottom portion of the inverter housing portion. The support portion supports the pump and the cooler. Any one of the pump and the cooler is disposed on one side in the circumferential direction with respect to the support portion when viewed from the axial direction, and the other thereof is disposed radially outside with respect to the support portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual view illustrating a drive apparatus according to an embodiment;

FIG. 2 is a perspective view illustrating the drive apparatus according to the embodiment;

FIG. 3 is a front view of the drive apparatus according to the embodiment;

FIG. 4 is a side view of the drive apparatus according to the embodiment; and

FIG. 5 is a perspective view illustrating a part of the drive apparatus according to the embodiment.

### DETAILED DESCRIPTION

A drive apparatus according to an embodiment of the present invention will be described below with reference to the drawings. Note that the scope of the present invention is not limited to an embodiment to be described below, but includes any modification thereof within the scope of the technical idea of the present invention.

The following description will be made with the direction of gravity being specified based on a positional relationship in a case where a drive apparatus 1 is mounted in a vehicle located on a horizontal road surface. In addition, in the drawings, an xyz coordinate system is shown appropriately as a three-dimensional orthogonal coordinate system. In the xyz coordinate system, a Z-axis direction indicates a vertical direction. In the following description, a +Z direction side is referred to as an “upper side”, and a −Z direction side is referred to as a “lower side”. In addition, an X-axis direction is a direction orthogonal to the Z-axis direction and shows a front-rear direction of the vehicle in which the drive apparatus 1 is mounted. In the following description, a +X direction side is referred to as a “vehicle rear side”, and a −X direction side is referred to as a “vehicle front side”. A Y-axis direction is a direction orthogonal to both the X-axis direction and the Z-axis direction, and is a width direction of the vehicle.

Unless otherwise specified in the following description, a direction (Y-axis direction) parallel to a motor axis J1 of a motor 2 is simply referred to as an “axial direction”. In the axial direction, a side (+Y side) which an arrow of a Y axis faces is referred to as “one side in the axial direction”. In the axial direction, a side (−Y side) opposite to the side which the arrow of the Y axis faces is referred to as the “other side in the axial direction”. A radial direction about the motor axis J1 is simply referred to as a “radial direction”, and a circumferential direction about the motor axis J1, that is, a direction around an axis of the motor axis J1 is simply referred to as a “circumferential direction”. The circumferential direction is indicated by an arrow θ in each drawing. In the circumferential direction, a side which the arrow θ faces is referred to as “one side in the circumferential direction”. In the circumferential direction, a side opposite to the side which the arrow θ faces is referred to as the “other side in the circumferential direction”. The one side in the circumferential direction is a side that advances clockwise around the motor axis J1 when viewed from one side in the axial direction. The other side in the circumferential direction is a side that advances counterclockwise around the motor axis J1 when viewed from one side in the axial direction. However, the “parallel direction” also includes a substantially parallel direction. Note that an upper side, a lower side, a vehicle front side, and a vehicle rear side are names for simply describing an arrangement relationship or the like of each part, and the actual arrangement relationship or the like may be an arrangement relationship or the like other than the arrangement relationship or the like indicated by these names.

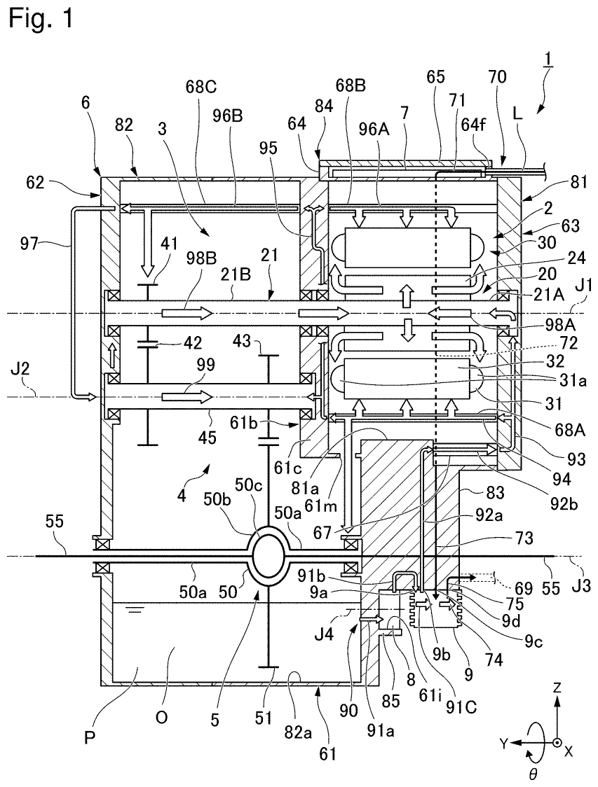

The drive apparatus 1 according to an illustrative embodiment of the present invention will be described below with reference to the drawings. FIG. 1 is a conceptual diagram of the drive apparatus 1 according to the embodiment. FIG. 1 is merely a conceptual diagram, and the arrangement and dimensions of units may differ from the actual arrangement and dimensions.

The drive apparatus 1 is mounted on a vehicle using a motor as a power source, such as a hybrid vehicle (HEV), a plug-in hybrid vehicle (PHV), or an electric vehicle (EV), and is used as the power source.

As illustrated in FIG. 1, the drive apparatus 1 includes the motor 2, a transmission mechanism 3, a housing 6, an inverter 7, a pump 8, a cooler 9, and oil O which is a fluid housed within the housing 6, and a refrigerant L.

As illustrated in FIG. 1, the motor 2 is housed inside a motor housing portion 81 of the housing 6. The motor 2 includes a rotor 20 and a stator 30 located radially outside the rotor 20. The motor 2 is an inner rotor motor including the rotor 20 disposed inside the stator 30 in a rotatable manner about the motor axis J1.

A current is supplied from a battery (not illustrated) to the stator 30 via an inverter or the like, and thus, the rotor 20 rotates. The rotor 20 includes a shaft 21, a rotor core 24, and a rotor magnet (not illustrated). The rotor 20 rotates about the motor axis J1. A torque of the rotor 20 is transmitted to the transmission mechanism 3.

The shaft 21 has a substantially cylindrical shape extending in the axial direction about the motor axis J1 facing a horizontal direction and the width direction of the vehicle. The shaft 21 rotates about the motor axis J1. The shaft 21 is a hollow shaft including a hollow portion defined therein. The shaft 21 extends in a direction of the motor axis J1 across the inside of the motor housing portion 81 and the inside of a transmission mechanism housing portion 82. The shaft 21 includes a first shaft 21A and a second shaft 21B that are coaxially disposed and coupled to each other.

Each of the first shaft 21A and the second shaft 21B has a substantially hollow cylindrical shape extending in the axial direction. The first shaft 21A is disposed inside the motor housing portion 81. The second shaft 21B is disposed inside the transmission mechanism housing portion 82. The first shaft 21A and the second shaft 21B are coupled to each other inside a partition wall 61c to be described later. The first shaft 21A and the second shaft 21B rotate synchronously about the motor axis J1. In the present embodiment, an inner diameter of an end portion on one side of the first shaft 21A in the axial direction is greater than an outer diameter of an end portion on the other side of the second shaft 21B in the axial direction. Splines meshing with each other are provided on an inner peripheral surface of the end portion on one side of the first shaft 21A in the axial direction and an outer peripheral surface of the end portion on the other side of the second shaft 21B in the axial direction. The end portion on one side of the first shaft 21A in the axial direction and the end portion on the other side of the second shaft 21B in the axial direction are fitted to each other, and thus, the first shaft 21A and the second shaft 21B are coupled to each other. Note that a configuration in which the end portion of the first shaft 21A is inserted into a hollow portion of the end portion of the second shaft 21B to be coupled may be adopted. In this case, splines meshing with each other are provided on an outer peripheral surface of the end portion of the first shaft 21A and the inner peripheral surface of the end portion of the second shaft 21B.

The rotor core 24 is formed by a plurality of laminated silicon steel sheets. The rotor core 24 has a substantially pillar shape extending in the axial direction. The plurality of rotor magnets (not illustrated) are fixed to the rotor core 24. In the rotor 20, magnetic poles formed by a plurality of rotor magnets are alternately disposed along the circumferential direction.

The stator 30 encloses the rotor 20 from radially outside. The stator 30 has a stator core 32, a coil 31, and an insulator (not illustrated) interposed between the stator core 32 and the coil 31. The stator 30 is held by the housing 6.

The stator core 32 includes a plurality of magnetic pole teeth (not illustrated) extending radially inward from an inner peripheral surface of an annular yoke. A coil wire is disposed between the magnetic pole teeth. The coil wire disposed between the magnetic pole teeth constitutes the coil 31. The coil wire is connected to the inverter 7 via a bus bar (not illustrated). The coil 31 includes coil ends 31a that project from axial end faces of the stator core 32. The coil end 31a projects from both sides in the axial direction relative to the rotor core 24 of the rotor 20.

As illustrated in FIG. 1, the transmission mechanism 3 transmits a power of the motor 2 to output shafts 55. The transmission mechanism 3 is housed inside the transmission mechanism housing portion 82 of the housing 6. The transmission mechanism 3 is connected to the shaft 21 inside the transmission mechanism housing portion 82. The transmission mechanism 3 is connected to the output shafts 55 inside the transmission mechanism housing portion 82. The transmission mechanism 3 includes a reduction gear 4 and a differential gear 5. The transmission mechanism 3 includes a plurality of gears. A torque output from the motor 2 is transmitted to the differential gear 5 through a plurality of gears of the reduction gear 4.

As illustrated in FIG. 1, the reduction gear 4 is connected to the shaft 21. More specifically, the reduction gear 4 is connected to the second shaft 21B. The reduction gear 4 has a function of increasing the torque output from the motor 2 in accordance with a reduction ratio by reducing a rotation speed of the motor 2. The reduction gear 4 transmits the torque output from the motor 2 to the differential gear 5. The reduction gear 4 has a first gear 41, a second gear 42, a third gear 43, and an intermediate shaft 45. The torque output from the motor 2 is transmitted to a ring gear 51 of the differential gear 5 via the shaft 21, the first gear 41, the second gear 42, the intermediate shaft 45, and the third gear 43. The number of gears, the gear ratios of the gears, and so on can be modified in various manners in accordance with a desired reduction ratio. In the present embodiment, the reduction gear 4 is a speed reducer of a parallel-axis gearing type, in which center axes of gears are disposed in parallel with the motor axis J1. Note that the reduction gear 4 may be another type of speed reducer.

The first gear 41 is provided on an outer peripheral surface of the shaft 21. The first gear 41 rotates about the motor axis J1 together with the shaft 21. The intermediate shaft 45 extends along an intermediate axis J2 parallel to the motor axis J1. The intermediate shaft 45 rotates about the intermediate axis J2. The intermediate shaft 45 has a hollow cylindrical shape extending in the axial direction. The second gear 42 and the third gear 43 are provided on an outer peripheral surface of the intermediate shaft 45. The second gear 42 and the third gear 43 are connected to each other with the intermediate shaft 45 interposed therebetween. The second gear 42 and the third gear 43 rotate about the intermediate axis J2. The second gear 42 meshes with the first gear 41. The third gear 43 meshes with the ring gear 51 of the differential gear 5. The third gear 43 is located closer to the partition wall 61c than the second gear 42.

As illustrated in FIG. 1, the differential gear 5 is connected to the motor 2 with the reduction gear 4 interposed therebetween. The differential gear 5 is a device for transmitting the torque output from the motor 2 to wheels of the vehicle. The differential gear 5 has a function of transmitting the same torque to axles of left and right wheels while absorbing a difference in speed between the left and right wheels when the vehicle is turning. The differential gear 5 includes the ring gear 51, a differential case 50, and a differential mechanism 50c disposed inside the differential case 50.

The ring gear 51 rotates about an output axis J3 parallel to the motor axis J1. The torque output from the motor 2 is transmitted to the ring gear 51 through the reduction gear 4. The ring gear 51 meshes with the third gear 43. The ring gear 51 is fixed to an outer peripheral surface of the differential case 50.

The differential case 50 includes a case portion 50b that houses the differential mechanism 50c therein, and a shaft portion 50a that projects to one side and the other side in the axial direction with respect to the case portion 50b. The shaft portion 50a has a tubular shape extending along the axial direction about the output axis J3. The shaft portion 50a rotates about the output axis J3 together with the ring gear 51.

A pair of output shafts 55 is connected to the differential gear 5. The pair of output shafts 55 projects from the differential case 50 of the differential gear 5 to one side and the other side in the axial direction. The pair of output shafts 55 is disposed inside the shaft portion 50a. The pair of output shafts 55 is rotatably supported on an inner peripheral surface of the shaft portion 50a with a bearing (not illustrated) interposed therebetween. The output shaft 55 rotates about the output axis J3. That is, the transmission mechanism 3 includes the output shaft 55 about the output axis J3 parallel to the motor axis J1.

The torque output from the motor 2 is transmitted to the ring gear 51 of the differential gear 5 via the shaft 21, the first gear 41, the second gear 42, the intermediate shaft 45, and the third gear 43, and is output to the output shaft 55 via the differential gear 5.

As illustrated in FIG. 1, the motor 2, the transmission mechanism 3, and the inverter 7 are housed in a space inside the housing 6. The housing 6 includes the motor housing portion 81, the transmission mechanism housing portion 82, an inverter housing portion 84, a support portion 83, and a pump holding portion 85. The motor 2 is housed inside the motor housing portion 81. The transmission mechanism 3 is housed inside the transmission mechanism housing portion 82. The inverter 7 is housed in the inverter housing portion 84. The support portion 83 supports the pump 8 and the cooler 9. The pump holding portion 85 constitutes a part of the pump 8. The pump holding portion 85 houses a mechanism of the pump 8. The support portion 83 according to the present embodiment supports the pump 8 by being coupled to the pump holding portion 85.

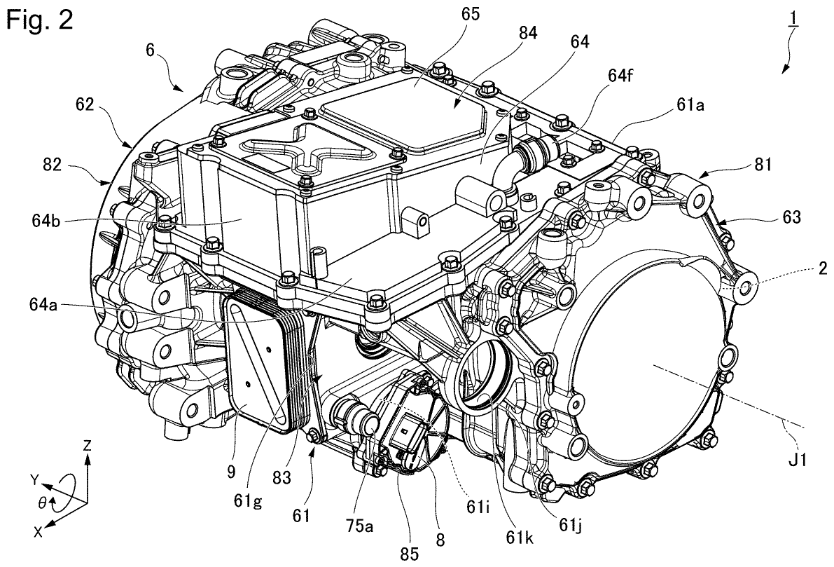

As illustrated in FIG. 2, the housing 6 includes a housing body 61, a gear cover 62, a motor cover 63, an inverter cover 64, and an upper lid member 65. The gear cover 62 is located on one side of the housing body 61 in the axial direction. The motor cover 63 is located on the other side in the axial direction of the housing body 61. The inverter cover 64 is located on the upper side of the housing body 61. The upper lid member 65 is located on the upper side of the inverter cover 64.

As illustrated in FIG. 1, the motor housing portion 81 includes the housing body 61 and the motor cover 63. The transmission mechanism housing portion 82 includes the housing body 61 and the gear cover 62. The inverter housing portion 84 includes the inverter cover 64 and the upper lid member 65. As described above, the housing 6 includes the motor housing portion 81, the transmission mechanism housing portion 82, and the inverter housing portion 84.

As illustrated in FIGS. 1 and 2, the housing body 61 includes a cylindrical peripheral wall portion 61a, a side plate portion 61b located on one side of the peripheral wall portion 61a in the axial direction, the support portion 83, the pump holding portion 85, and an output shaft support portion 61j. The motor 2 is housed inside the peripheral wall portion 61a. In the present embodiment, the peripheral wall portion 61a is a part of the motor housing portion 81.

As illustrated in FIG. 1, the side plate portion 61b includes a partition wall 61c. The partition wall 61c covers an opening on one side of the peripheral wall portion 61a in the axial direction. In the present embodiment, the partition wall 61c is a part of the motor housing portion 81.

As illustrated in FIGS. 1 and 2, the support portion 83 supports the pump 8 and the cooler 9. The support portion 83 projects radially outside from the peripheral wall portion 61a. The support portion 83 is located on the other side in the axial direction with respect to the side plate portion 61b. The support portion 83 is located on the lower side of the inverter cover 64 to be described later. The support portion 83 is connected to the peripheral wall portion 61a, the side plate portion 61b, and the inverter cover 64. The support portion 83 includes a cooler support portion 61g. The output shaft 55 penetrates the support portion 83 in the axial direction.

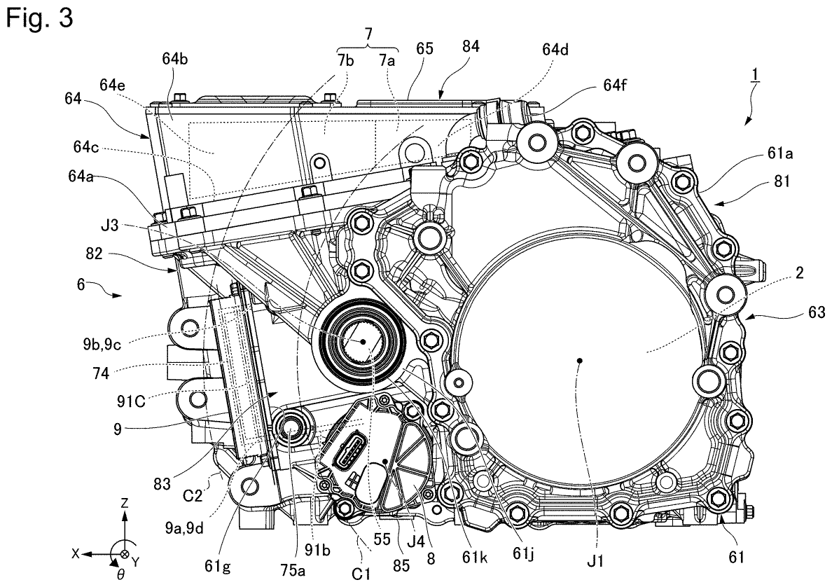

As illustrated in FIGS. 2 and 3, the cooler support portion 61g is provided on a surface facing the vehicle rear side (+X direction side) of the outer peripheral surface of the support portion 83. In the present embodiment, four openings (not illustrated) are provided in the cooler support portion 61g. Four openings are connected to an inflow port 9a, an outflow port 9b, a refrigerant inflow port 9c, and a refrigerant outflow port 9d of the cooler 9 to be described later.

As illustrated in FIG. 1, the pump holding portion 85 is located on the lower side of the support portion 83 and is coupled to an end portion on the lower side of the support portion 83. That is, the support portion 83 supports the pump 8 from the upper side. The pump holding portion 85 is located radially outside with respect to the peripheral wall portion 61a. That is, the pump 8 is located radially outside with respect to the peripheral wall portion 61a. A pump mechanism housing hole 61i is provided in the pump holding portion 85. The pump mechanism housing hole 61i is a hole that houses a mechanism of the pump 8. The pump mechanism housing hole 61i is a hole extending in the axial direction.

As illustrated in FIG. 2, the output shaft support portion 61j projects radially outside from an end portion on the other side of the peripheral wall portion 61a in the axial direction. The output shaft support portion 61j supports the output shaft 55 via a bearing (not illustrated). An output shaft passing hole 61k that is opened in the axial direction is provided in the output shaft support portion 61j. The output shaft 55 passes through the output shaft passing hole 61k in the axial direction.

As illustrated in FIG. 2, the motor cover 63 is fixed to the peripheral wall portion 61a of the housing body 61. The motor cover 63 closes an opening on the other side of the housing body 61 in the axial direction. In the present embodiment, the motor cover 63 is a part of the motor housing portion 81.

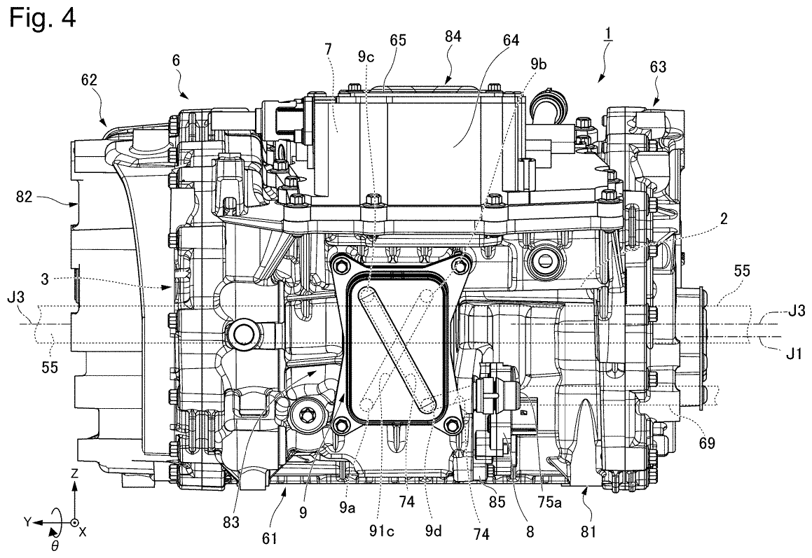

As illustrated in FIG. 4, the gear cover 62 is fixed to one side of the housing body 61 in the axial direction. As illustrated in FIG. 1, the gear cover 62 has a recessed shape that is opened toward the housing body 61 (that is, the other side in the axial direction). The opening of the gear cover 62 is covered with the side plate portion 61b. The transmission mechanism 3 is housed in a space between the gear cover 62 and the side plate portion 61b. In the present embodiment, the gear cover 62 is a part of the transmission mechanism housing portion 82.

As illustrated in FIGS. 2 and 3, the inverter cover 64 is fixed to the upper side of the housing body 61. The inverter cover 64 is disposed across the upper side of the peripheral wall portion 61a and the upper side of the support portion 83. The inverter cover 64 houses the inverter 7 therein. The inverter cover 64 includes a bottom plate portion 64a and a box-shaped portion 64b.

The bottom plate portion 64a is a portion on the lower side of the inverter cover 64. The bottom plate portion 64a is fixed to the upper side of the housing body 61. The bottom plate portion 64a has a substantially rectangular plate shape when viewed from the upper side. The bottom plate portion 64a is located on the lower side from the vehicle front side (−X direction side) toward the vehicle rear side (+X direction side). An end portion of the bottom plate portion 64a on the vehicle front side (−X direction side) is located on the vehicle rear side (+X direction side) with respect to an end portion of the housing body 61 on the vehicle front side (−X direction side). An end portion of the bottom plate portion 64a on the vehicle rear side (+X direction side) is located on the vehicle rear side (+X direction side) with respect to an end portion of the support portion 83 on the vehicle rear side (+X direction side). The box-shaped portion 64b is connected to the upper side of the bottom plate portion 64a. In the present embodiment, the bottom plate portion 64a is a part of the inverter housing portion 84.

The box-shaped portion 64b extends to the upper side from the bottom plate portion 64a. When viewed from the upper side, an outer shape of the box-shaped portion 64b is substantially rectangular. The box-shaped portion 64b houses the inverter 7 therein. As illustrated in FIG. 3, the outer shape of the box-shaped portion 64b is substantially trapezoidal when viewed in the axial direction. The bottom portion 64c of the box-shaped portion 64b is located on the lower side from the vehicle front side (−X direction side) toward the vehicle rear side (+X direction side). An end portion on the upper side of the box-shaped portion 64b extends substantially in a vehicle front-rear direction (X-axis direction) from the vehicle front side (−X direction side) to the vehicle rear side (+X direction side). Thus, a dimension of the box-shaped portion 64b in the vertical direction increases from the vehicle front side (−X direction side) toward the vehicle rear side (+X direction side). That is, a dimension of an end portion of the box-shaped portion 64b in the vertical direction on the vehicle rear side (+X direction side) is greater than a dimension of an end portion in the vertical direction on the vehicle front side (−X direction side). A first region 64d and a second region 64e are provided inside the box-shaped portion 64b.

The first region 64d is a portion of the inside of the box-shaped portion 64b on the vehicle front side (−X direction side). The first region 64d is located on the upper side of the peripheral wall portion 61a. The first region 64d overlaps the peripheral wall portion 61a when viewed from the vertical direction. That is, the first region 64d is located on the upper side of the motor housing portion 81. That is, the first region 64d is located radially outside the motor housing portion 81. The second region 64e is a portion of the inside of the box-shaped portion 64b on the vehicle rear side (+X direction side). The second region 64e is located on the upper side of the support portion 83. That is, the second region 64e is located between the first region 64d and the other side of the support portion 83 in the circumferential direction in the circumferential direction. The second region 64e is a region that does not overlap the peripheral wall portion 61a when viewed from the vertical direction and is provided at a position different from the peripheral wall portion 61a when viewed from the vertical direction. A dimension of the second region 64e in the vertical direction is greater than a dimension of the first region 64d in the vertical direction. That is, a dimension of the second region 64e in the circumferential direction is greater than a dimension of the first region 64d in the circumferential direction.

The upper lid member 65 is fixed to the upper side of the inverter cover 64. The upper lid member 65 closes an opening on the upper side of the box-shaped portion 64b. The upper lid member 65 has a substantially rectangular plate shape. In the present embodiment, the upper lid member 65 is a part of the inverter housing portion 84.

An oil pool P in which the oil O to be described later is gathered is provided in a lower region inside the transmission mechanism housing portion 82. In the present embodiment, the bottom portion 81a of the motor housing portion 81 is located on the upper side with respect to the bottom portion 82a of the transmission mechanism housing portion 82. In addition, a partition wall hole (not illustrated) is provided in the partition wall 61c. The partition wall hole allows the inside of the motor housing portion 81 and the inside of the transmission mechanism housing portion 82 to communicate with each other. The oil O gathered in a lower region inside the motor housing portion 81 moves to the oil pool P inside the transmission mechanism housing portion 82 through the partition wall hole.

As illustrated in FIGS. 1 and 2, the transmission mechanism housing portion 82 is located on one side of the motor housing portion 81 in the axial direction. The inverter housing portion 84 is located on the upper side of the motor housing portion 81. That is, the inverter housing portion 84 is located radially outside the motor housing portion 81. In addition, the transmission mechanism housing portion 82 projects to the vehicle rear side (+X direction side) with respect to the motor housing portion 81. That is, the transmission mechanism housing portion 82 projects radially outside with respect to the motor housing portion 81. The inverter housing portion 84 projects to the vehicle rear side (+X direction side) with respect to the motor housing portion 81. That is, the inverter housing portion 84 projects radially outside with respect to the motor housing portion 81. Therefore, a space is formed on the vehicle rear side (+X direction side) of the motor housing portion 81, the other side of the transmission mechanism housing portion 82 in the axial direction, and the lower side of the inverter housing portion 84. Hereinafter, such a space is referred to as a dead space.

In the present embodiment, as described above, the support portion 83 is located radially outside the motor housing portion 81 and on the lower side of the inverter housing portion 84. In addition, the support portion 83 is located on the other side of the transmission mechanism housing portion 82 in the axial direction. That is, the support portion 83 is disposed in the dead space.

In addition, as described above, the support portion 83 is connected to the peripheral wall portion 61a. That is, the support portion 83 is connected to an outer peripheral portion of the motor housing portion 81. As described above, the support portion 83 is connected to an end portion on the lower side of the inverter cover 64. That is, the support portion 83 is connected to a bottom portion of the inverter housing portion 84. As described above, the support portion 83 is connected to the side plate portion 61b. That is, the support portion 83 is connected to the transmission mechanism housing portion 82. That is, the support portion 83 is connected to the motor housing portion 81, the transmission mechanism housing portion 82, and the inverter housing portion 84.

As illustrated in FIG. 1, the oil O is circulated in an oil passage 90 provided in the housing 6 when the drive apparatus 1 is driven. The oil passage 90 is a route of the oil O through which the oil O flows from the oil pool P to the motor 2 and the transmission mechanism 3. The oil O is used for cooling the motor 2. In addition, the oil O is used to lubricate the reduction gear 4 and the differential gear 5. Note that the oil O may be used to lubricate at least one bearing disposed inside the drive apparatus 1. An oil equivalent to a lubricating oil (ATF: Automatic Transmission Fluid) for an automatic transmission having a low viscosity is preferably used as the oil O so that the oil O can perform functions of a lubricating oil and a cooling oil. Note that, in the present embodiment, the fluid is the oil O.

As illustrated in FIG. 1, the oil passage 90 is a flow path through which the oil O flows. That is, the drive apparatus 1 includes a flow path through which the fluid (oil O) flows. The oil passage 90 is formed across the motor housing portion 81, the transmission mechanism housing portion 82, and the support portion 83. The oil passage 90 is a route of the oil O that guides the oil O from the oil pool P to the oil pool P again via the motor 2 and the transmission mechanism 3.

Note that, in the present specification, the “oil passage” refers to a route of the oil O circulated inside the drive apparatus 1. Therefore, the “oil passage” is a concept that includes not only a “flow path”, in which a steady flow of the oil O steadily traveling in one direction is formed, but also a route (for example, oil pool P) in which the oil O is allowed to temporarily stay, and a route along which the oil O drips.

As illustrated in FIG. 1, in the oil passage 90, the oil O flows from the oil pool P through the motor housing portion 81 and the transmission mechanism housing portion 82, and is supplied to the motor 2 and the transmission mechanism 3. The oil O supplied to the motor 2 cools the motor 2 by removing heat from the rotor 20 and the stator 30 while flowing along the outer peripheral surface of the stator 30 and the rotor 20. The oil O having flowed along the outer peripheral surface of the stator 30 and the rotor 20 drops downward and is gathered in the lower region inside the motor housing portion 81. The oil O gathered in the lower region inside the motor housing portion 81 returns to the oil pool P through a partition wall hole (not illustrated). The oil O scraped up by the ring gear 51 to be described later or supplied to the transmission mechanism 3 through the flow paths to be described later or the like is supplied to tooth surfaces of gears of the transmission mechanism 3 to lubricate the tooth surfaces of the gears. The oil O having flowed along the tooth surfaces of the gears drops downward and returns to the oil pool P. Note that a volume of the oil O in the oil pool P is, for example, such that a part of the bearing of the differential gear 5 is immersed in the oil O when the drive apparatus 1 is stopped.

The oil passage 90 includes a first flow path 91a, a second flow path 91b, an intra-cooler flow path 91c, a connection flow path 92a, an intra-relay pipe flow path 92b, an intra-motor housing portion flow path 93, a third flow path 94, a fourth flow path 95, a fifth flow path 96A, a sixth flow path 96B, a seventh flow path 97, a first intra-shaft flow path 98A, a second intra-shaft flow path 98B, and an intra-intermediate shaft flow path 99. The pump 8 and the cooler 9 are provided in the route of the oil passage 90. The pump 8 pumps the oil O. The cooler 9 cools the oil O flowing through the intra-cooler flow path 91c.

In the present embodiment, the first flow path 91a, the second flow path 91b, the connection flow path 92a, the intra-motor housing portion flow path 93, the fourth flow path 95, and the seventh flow path 97 are provided inside a wall portion of the housing 6. In addition, the first intra-shaft flow path 98A and the second intra-shaft flow path 98B are provided inside the shaft 21, and the intra-intermediate shaft flow path 99 is provided inside the intermediate shaft 45. Therefore, it is not necessary to separately prepare a pipe material in order to provide these flow paths, and a decrease in the number of components can be achieved.

The first flow path 91a is connected to the oil pool P and the pump 8 to each other. In the present embodiment, the first flow path 91a is provided inside the wall portion of the housing 6. More specifically, the first flow path 91a is a flow path extending at least toward the other side in the axial direction inside the support portion 83. In the present embodiment, the first flow path 91a is a linear flow path.

In the present embodiment, the pump 8 is an electric pump driven by electricity. The pump 8 sucks up the oil O from the oil pool P through the first flow path 91a, pumps the oil O, and supplies the oil O to the motor 2 and the transmission mechanism 3 through the second flow path 91b, the cooler 9, the connection flow path 92a, and the like. That is, the drive apparatus 1 includes the pump 8 that pumps the oil O within the oil passage 90. As shown in FIGS. 3 and 4, in the present embodiment, the pump 8 is disposed on the lower side of the support portion 83. That is, the pump 8 is disposed on one side in the circumferential direction with respect to the support portion 83 when viewed from the axial direction. A position of a lower end of the pump 8 is located on the upper side with respect to positions of lower ends of the motor housing portion 81 and the transmission mechanism housing portion 82. That is, a position of an end portion on one side of the pump 8 in the circumferential direction is located on the other side in the circumferential direction with respect to positions of end portions on one side of the motor housing portion 81 and the transmission mechanism housing portion 82 in the circumferential direction. An end portion on the other side of the pump 8 in the axial direction is located on one side in the axial direction with respect to an end portion on the other side of the motor housing portion 81 in the axial direction. When viewed from the lower side (−Z direction side), the pump 8 overlaps the inverter housing portion 84. That is, the pump 8 is hidden on the lower side of the inverter housing portion 84 when viewed from the upper side. In addition, an imaginary arc C1 passing through an end portion of the pump 8 radially outside about the motor axis J1 overlaps the inverter housing portion 84. That is, the pump 8 overlaps the inverter housing portion 84 in the circumferential direction. Therefore, in the present embodiment, the pump 8 is disposed in the dead space.

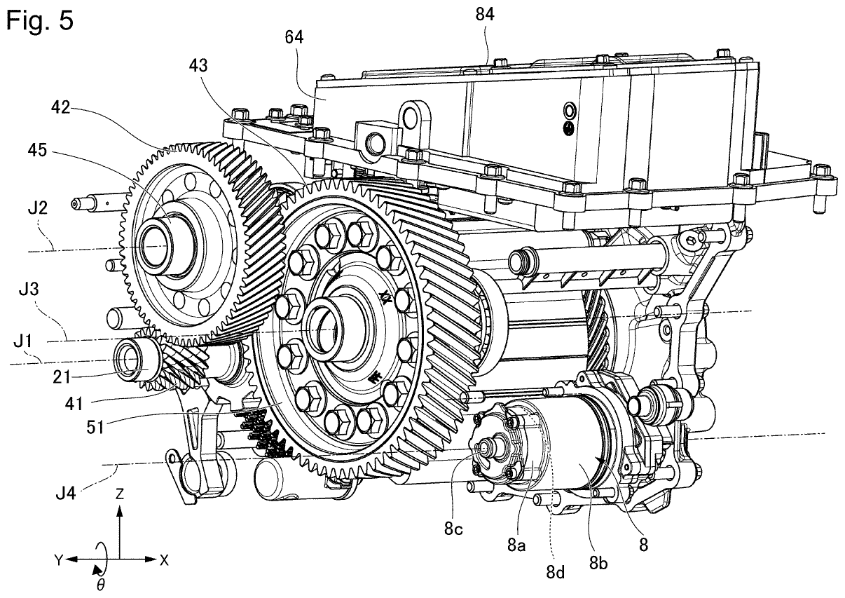

The pump 8 is housed in a pump mechanism housing hole 61i extending in the axial direction of the housing 6. The pump 8 is supported by the support portion 83 by coupling the pump holding portion 85 to the support portion 83. As illustrated in FIG. 5, the pump 8 includes a pump mechanism 8a, a pump motor 8b, a suction port 8c, an ejection port 8d, and a pump holding portion 85 (see FIG. 2, omitted in FIG. 5) that houses these components. The suction port 8c of the pump 8 is located on one side in the axial direction. The pump motor 8b is located on the other side in the axial direction.

The pump mechanism 8a is located on one side in the axial direction with respect to the pump motor 8b. The suction port 8c is disposed at an end portion on one side of the pump mechanism 8a in the axial direction. The ejection port 8d is disposed on the upper side of the pump mechanism 8a. In the present embodiment, the pump 8 is a trochoidal pump in which outer and inner gears (not illustrated) rotate while being meshed with each other. The inner gear of the pump mechanism 8a is rotated by the pump motor 8b. The gap between the inner gear and the outer gear of the pump mechanism 8a is connected to the suction port 8c and the ejection port 8d. The suction port 8c is connected to the first flow path 91a, and the ejection port 8d is connected to the second flow path 91b. The pump 8 sucks up the oil O from the oil pool P through the first flow path 91a and supplies the oil O to the second flow path 91b.

The pump motor 8b rotates about a rotation axis J4. The rotation axis J4 is parallel to the motor axis J1. The rotation axis J4 is located on the lower side with respect to the axes J1, J2, and J3 of the shafts included in the motor 2 and the transmission mechanism 3. A dimension of the pump 8 having the pump motor 8b is likely to be longer in a direction of the rotation axis J4 than in the radial direction of the rotation axis J4. Thus, for example, when the pump 8 is disposed such that the rotation axis J4 faces a direction orthogonal to the motor axis J1, the pump 8 projects in the radial direction from the dead space, and there is a concern that a size of the drive apparatus 1 increases in the radial direction. However, according to the present embodiment, the pump 8 is disposed such that the rotation axis J4 is parallel to the motor axis J1. Thus, the entire pump 8 can be disposed in the dead space. As a result, it is possible to suppress an increase in a projection area of the drive apparatus 1 in the radial direction and the axial direction, and it is possible to downsize the entire drive apparatus 1.

As illustrated in FIG. 1, the second flow path 91b is connected to the pump 8 and the cooler 9. More specifically, the second flow path 91b is connected to the ejection port 8d of the pump 8 and the inflow port 9a of the cooler 9. In the present embodiment, the second flow path 91b is provided inside the housing 6. More specifically, the second flow path 91b is a flow path extending in the substantially X-axis direction through the inside of the support portion 83. In the present embodiment, the second flow path 91b is linear.

As illustrated in FIG. 3, the cooler 9 is fixed to the cooler support portion 61g of the support portion 83. The cooler 9 is supported by the support portion 83. The cooler 9 is disposed on the vehicle rear side (+X direction side) with respect to the support portion 83. That is, the cooler 9 is disposed radially outside with respect to the support portion 83. In addition, the cooler 9 is disposed radially outside the output shaft 55. As illustrated in FIGS. 3 and 4, a position of a lower end of the cooler 9 is located on the upper side with respect to the positions of the lower ends of the motor housing portion 81 and the transmission mechanism housing portion 82. That is, a position of an end portion on one side of the cooler 9 in the circumferential direction is located on the other side in the circumferential direction with respect to the positions of the end portions on one side of the motor housing portion 81 and the transmission mechanism housing portion 82 in the circumferential direction. An end portion on the other side of the cooler 9 in the axial direction is located on one side in the axial direction with respect to the end portion on the other side of the motor housing portion 81 in the axial direction. The cooler 9 overlaps the inverter housing portion 84 when viewed from the lower side (−Z direction side). That is, the cooler 9 is hidden on the lower side of the inverter housing portion 84 when viewed from the upper side. In addition, an imaginary arc C2 passing through an end portion of the cooler 9 radially outside about the motor axis J1 overlaps the inverter housing portion 84. That is, the cooler 9 overlaps the inverter housing portion 84 in the circumferential direction. Therefore, in the present embodiment, the cooler 9 is disposed in the dead space.

As illustrated in FIG. 1, the second flow path 91b and the connection flow path 92a are connected to the cooler 9. The intra-cooler flow path 91c through which the oil O flows is provided in the cooler 9. As illustrated in FIG. 4, the intra-cooler flow path 91c and the second flow path 91b are connected through the inflow port 9a of the cooler. The intra-cooler flow path 91c and the connection flow path 92a are connected through the outflow port 9b of the cooler. The intra-cooler flow path 91c connects the inflow port 9a and the outflow port 9b inside the cooler 9. As illustrated in FIGS. 3 and 4, the inflow port 9a is located on the lower side with respect to the output axis J3. The outflow port 9b is located on the upper side with respect to the output axis J3. The intra-cooler flow path 91c is disposed to overlap the output axis J3 in the radial direction of the motor axis J1. As illustrated in FIG. 3, the intra-cooler flow path 91c extends in the circumferential direction of the output axis J3 when viewed in the axial direction.

As will be described later, an intra-cooler refrigerant flow path 74 is provided inside the cooler 9. The refrigerant L cooled by a radiator (not illustrated) flows within the intra-cooler refrigerant flow path 74. Thus, the oil O passing through the intra-cooler flow path 91c is cooled by heat exchange with the refrigerant L passing through the intra-cooler refrigerant flow path 74.

As described above, in the present embodiment, the pump 8 and the cooler 9 are disposed in the dead space. Thus, as illustrated in FIG. 3, the pump 8 and the cooler 9 overlap the transmission mechanism housing portion 82 when viewed from the axial direction. Since the transmission mechanism 3 is housed inside the transmission mechanism housing portion 82, a projection area of the transmission mechanism housing portion 82 in the axial direction is determined depending on the size of each gear of the transmission mechanism 3 or the like. The size of each gear constituting the transmission mechanism 3 is set to satisfy a desired gear ratio. Thus, it is difficult to reduce the projection area of the transmission mechanism housing portion 82 in the axial direction without changing the size of each gear. However, according to the present embodiment, the pump 8 and the cooler 9 overlap the transmission mechanism housing portion 82 in the axial direction. Thus, it is possible to suppress the projection area of the drive apparatus 1 in the axial direction from being increased by the cooler 9 and the pump 8 as compared with the projection area of the drive apparatus 1 in the axial direction when the pump 8 and the cooler 9 do not overlap the transmission mechanism housing portion 82 in the axial direction.

In the present embodiment, the pump 8 and the cooler 9 are disposed in the dead space. Thus, as illustrated in FIG. 4, the pump 8 and the cooler 9 overlap the motor housing portion 81 when viewed from the vehicle rear side (+X direction side). That is, the pump 8 and the cooler 9 overlap the motor housing portion 81 when viewed from the radial direction. The motor 2 is housed inside the motor housing portion 81. The projected area of the motor housing portion 81 in the radial direction is determined depending on, for example, sizes of the rotor 20 and the stator 30. The sizes of the rotor 20 and the stator 30 are set to satisfy a desired output torque. Thus, it is difficult to reduce the projected area of the motor housing portion 81 in the radial direction without changing the desired output torque. However, according to the present embodiment, the pump 8 and the cooler 9 overlap the motor housing portion 81 in the radial direction. It is possible to suppress the projected area of the drive apparatus 1 in the radial direction from being increased by the pump 8 and the cooler 9 as compared with the projected area of the drive apparatus 1 in the radial direction when the pump 8 and the cooler 9 do not overlap the motor housing portion 81 in the radial direction.

In the present embodiment, the pump 8 and the cooler 9 are disposed in the dead space. Thus, as illustrated in FIG. 3, the pump 8 and the cooler 9 overlap the inverter housing portion 84 when viewed from the lower side (−Z direction side). That is, the pump 8 and the cooler 9 overlap the inverter housing portion 84 in the vertical direction. In addition, as described above, the pump 8 and the cooler 9 overlap the inverter housing portion 84 in the circumferential direction. The inverter 7 is housed in the inverter housing portion 84. The projection areas of the inverter housing portion 84 in the vertical direction and the circumferential direction are determined depending on a size of the inverter 7. The size of the inverter 7 is determined depending on, for example, the number and size of electronic components. Thus, it is difficult to reduce the projection areas of the inverter housing portion 84 in the vertical direction and the circumferential direction without changing the electronic components and the like. However, in the present embodiment, the pump 8 and the cooler 9 overlap the inverter housing portion 84 in the vertical direction and the circumferential direction. Thus, it is possible to suppress the projection areas of the drive apparatus 1 in the vertical direction and the circumferential direction from being increased by the pump 8 and the cooler 9 as compared with the projection areas of the drive apparatus 1 in the vertical direction and the circumferential direction when the pump 8 and the cooler 9 do not overlap the inverter housing portion 84 in the vertical direction and the circumferential direction.

As illustrated in FIG. 1, the connection flow path 92a is connected to the cooler 9 and the intra-relay pipe flow path 92b. More specifically, one end of the connection flow path 92a is connected to the outflow port 9b of the cooler 9. The other end of the connection flow path 92a is connected to the intra-motor housing portion flow path 93 to be described later through the intra-relay pipe flow path 92b. That is, the oil passage 90 has the connection flow path 92a connected to the intra-motor housing portion flow path 93 and the cooler 9. In the present embodiment, the connection flow path 92a extends linearly inside the support portion 83 toward the vehicle front side (−X direction side).

The intra-relay pipe flow path 92b is connected to the connection flow path 92a and the intra-motor housing portion flow path 93. The intra-relay pipe flow path 92b is provided inside the relay pipe 67. The relay pipe 67 has a hollow tubular shape extending substantially in the axial direction. The relay pipe 67 is connected to the inside of the support portion 83 and the inside of the motor cover 63. The oil O is supplied from the support portion 83 to the motor housing portion 81 through the intra-relay pipe flow path 92b.

The intra-motor housing portion flow path 93 is connected to the intra-relay pipe flow path 92b, the third flow path 94, and the first intra-shaft flow path 98A. The intra-motor housing portion flow path 93 is provided inside the motor cover 63. That is, the oil passage 90 includes the intra-motor housing portion flow path 93 provided in the motor housing portion 81. In the present embodiment, the intra-motor housing portion flow path 93 extends linearly from a connection portion with the intra-relay pipe flow path 92b toward a connection portion with the first intra-shaft flow path 98A. The intra-motor housing portion flow path 93 branches off to the third flow path 94 in the route. As a result, the oil O is supplied to the first intra-shaft flow path 98A and the third flow path 94.

The third flow path 94 is connected to the intra-motor housing portion flow path 93 and the fourth flow path 95. The third flow path 94 is provided inside a first supply pipe 68A. The first supply pipe 68A has a hollow tubular shape extending substantially in the axial direction. The first supply pipe 68A is connected to the inside of the motor cover 63 and the inside of the partition wall 61c. The first supply pipe 68A is disposed on substantially the upper side of the motor 2 inside the motor housing portion 81. In the third flow path 94, the oil O flows through substantially the upper side of the motor 2 along the axial direction.

An injection hole (not illustrated) opened to the motor 2 side is provided in the first supply pipe 68A. Thus, in the third flow path 94, a part of the oil O is injected to the motor 2 through the injection hole. That is, the third flow path 94 supplies the oil O to the motor 2 from radially outside. The oil O supplied to the motor 2 cools the entire motor 2 by removing heat from the rotor 20 and the stator 30 when flowing along surfaces of the rotor 20 and the stator 30. Furthermore, the oil O drops from the motor 2, is gathered in the bottom portion 81a of the motor housing portion 81, and returns to the oil pool P through a partition wall hole (not illustrated). A part of the oil O supplied to the third flow path 94 reaches the fourth flow path 95.

In addition, a jet hole through which the oil O is jetted to the bearing within the transmission mechanism housing portion 82 through an opening 61m provided in the partition wall 61c is provided in the first supply pipe 68A. That is, in the third flow path 94, a part of the oil O is supplied to the bearing through the jet hole and the opening 61m.

The fourth flow path 95 is connected to the third flow path 94, the fifth flow path 96A, the sixth flow path 96B, and the intra-intermediate shaft flow path 99. The fourth flow path 95 extends inside the partition wall 61c. That is, the oil passage 90 extends to the motor housing portion 81. In the present embodiment, the fourth flow path 95 extends linearly from a connection portion with the third flow path 94 toward a connection portion with the fifth flow path 96A and the sixth flow path 96B. One end of the fourth flow path 95 branches off to the fifth flow path 96A and the sixth flow path 96B. In addition, the fourth flow path 95 branches off to the intra-intermediate shaft flow path 99 in the route. As a result, the oil O is supplied to the fifth flow path 96A, the sixth flow path 96B, and the intra-intermediate shaft flow path 99.

The oil O passing through the fifth flow path 96A passes through the inside of a second supply pipe 68B. The second supply pipe 68B has a hollow tubular shape extending substantially in the axial direction. The second supply pipe 68B is connected to the inside of the partition wall 61c and the motor cover 63. The second supply pipe 68B is disposed on substantially the upper side of the motor 2 inside the motor housing portion 81. In the fifth flow path 96A, the oil O flows through substantially the upper side of the motor 2 along the axial direction.

An injection hole (not illustrated) opened to the motor 2 side is provided in the second supply pipe 68B. Thus, in the fifth flow path 96A, the oil O is injected to the motor 2 through the injection hole, and similarly to the oil O injected to the motor 2 in the above-described third flow path 94, the oil O cools the entire motor 2, then is gathered in the bottom portion 81a of the motor housing portion 81, and returns to the oil pool P through a partition wall hole (not illustrated).

The sixth flow path 96B is connected to the fourth flow path 95 and the seventh flow path 97. The oil O flowing through the sixth flow path 96B passes through the inside of a third supply pipe 68C. The third supply pipe 68C has a hollow tubular shape extending substantially in the axial direction. The third supply pipe 68C is connected to the inside of the partition wall 61c and the inside of the gear cover 62. The third supply pipe 68C is disposed on substantially the upper side of the transmission mechanism 3 inside the transmission mechanism housing portion 82. The oil O supplied to the sixth flow path 96B flows through substantially the upper side of the transmission mechanism 3 along the axial direction.

An injection hole (not illustrated) opened to the transmission mechanism 3 side is provided in the third supply pipe 68C. Thus, in the sixth flow path 96B, a part of the oil O is diffused into the transmission mechanism housing portion 82 through the injection hole. The oil O diffused into the transmission mechanism housing portion 82 is supplied to the tooth surfaces of the gears of the transmission mechanism 3 to lubricate the gears. Furthermore, the oil O drops from the transmission mechanism 3 and returns to the oil pool P. A part of the oil O supplied to the sixth flow path 96B reaches the seventh flow path 97.

The seventh flow path 97 is connected to the sixth flow path 96B, the second intra-shaft flow path 98B, and the intra-intermediate shaft flow path 99. The oil O flowing through the seventh flow path 97 passes through the inside of the gear cover 62. That is, the oil O flowing through the oil passage 90 passes through the transmission mechanism housing portion 82. One end of the seventh flow path 97 is connected to the second intra-shaft flow path 98B. The seventh flow path 97 branches off to the intra-intermediate shaft flow path 99 in the route. As a result, the oil O is supplied to the second intra-shaft flow path 98B and the intra-intermediate shaft flow path 99.

The second intra-shaft flow path 98B is connected to the seventh flow path 97 and the first intra-shaft flow path 98A. The oil O flowing through the second intra-shaft flow path 98B passes through the inside of the second shaft 21B. As described above, the second shaft 21B has a hollow cylindrical shape extending in the axial direction. The second shaft 21B is connected to the inside of the gear cover 62 and the first shaft 21A inside the partition wall 61c. The second intra-shaft flow path 98B is a flow path extending in the axial direction through the inside of the transmission mechanism housing portion 82. The oil O is supplied to the first intra-shaft flow path 98A.

The first intra-shaft flow path 98A is connected to the intra-motor housing portion flow path 93 and the second intra-shaft flow path 98B. The oil O flowing through the first intra-shaft flow path 98A passes through the inside of the first shaft 21A. As described above, the first shaft 21A has a hollow cylindrical shape extending in the axial direction. The first shaft 21A is connected to the inside of the motor cover 63 and the second shaft 21B. The first intra-shaft flow path 98A is a flow path extending in the axial direction through the inside of the motor housing portion 81. The oil O is supplied to the first intra-shaft flow path 98A from the intra-motor housing portion flow path 93 and the second intra-shaft flow path 98B.

A communication hole (not illustrated) opened radially outside is provided in the first shaft 21A. In the first intra-shaft flow path 98A, a centrifugal force accompanying the rotation of the first shaft 21A is applied to the oil O. As a result, the oil O is scattered radially outside from the first shaft 21A through the communication hole. Similarly to the oil O injected to the motor 2, in the above-described third flow path 94, the oil O scattered from the first shaft 21A cools the entire motor 2, then is gathered in the bottom portion 81a of the motor housing portion 81, and returns to the oil pool P through a partition wall hole (not illustrated). In addition, since the first intra-shaft flow path 98A has a negative pressure with the scattering of the oil O, the oil O in the intra-motor housing portion flow path 93 and the second intra-shaft flow path 98B is sucked into the first shaft 21A, and the oil O flows into the first intra-shaft flow path 98A.

The intra-intermediate shaft flow path 99 is connected to the seventh flow path 97 and the fourth flow path 95. The oil O flowing through the intra-intermediate shaft flow path 99 passes through the inside of the intermediate shaft 45. As described above, the intermediate shaft 45 has a hollow cylindrical shape extending in the axial direction. The intermediate shaft 45 is connected to the inside of the gear cover 62 and the inside of the partition wall 61c via a bearing. The intra-intermediate shaft flow path 99 is a flow path extending in the axial direction through the inside of the transmission mechanism housing portion 82.

As illustrated in FIG. 1, a part of the ring gear 51 is immersed in the oil pool P. Thus, when the drive apparatus 1 is driven, the oil O gathered in the oil pool P is scraped up by the ring gear 51 by the operation of the transmission mechanism 3 and is diffused into the transmission mechanism housing portion 82. The oil O diffused into the transmission mechanism housing portion 82 is supplied to the gears of the transmission mechanism 3 and spreads the oil O on the tooth surfaces of the gears. The oil O supplied to the transmission mechanism 3 drops into the oil pool P.

The inverter 7 is electrically connected to the motor 2. The inverter 7 controls a current to be supplied to the motor 2. As illustrated in FIG. 3, the inverter 7 is housed in the inverter housing portion 84. The inverter 7 includes at least one control board (not illustrated), a first electronic component 7a, and a second electronic component 7b. The control board has a plate shape. For example, the control board is fixed to the bottom portion 64c of the box-shaped portion 64b. The control board is disposed substantially parallel to the bottom portion 64c. The control board holds the first electronic component 7a and the second electronic component 7b.

The first electronic component 7a is an electronic component such as a transistor. The second electronic component 7b is an electronic component such as a capacitor. In the present embodiment, the second electronic component 7b has a dimension in the vertical direction larger than the first electronic component 7a. That is, the second electronic component 7b has a dimension in the circumferential direction larger than the first electronic component 7a. The first electronic component 7a is disposed in the first region 64d, and the second electronic component 7b is disposed in the second region 64e. As described above, a dimension of the second region 64e in the circumferential direction is larger than a dimension of the first region 64d in the circumferential direction. That is, the first electronic component 7a having a small dimension in the circumferential direction is disposed in the first region 64d having a small dimension in the circumferential direction, and the second electronic component 7b having a large dimension in the circumferential direction is disposed in the second region 64e having a large dimension in the circumferential direction. As a result, a position of an end portion on the upper side of the first electronic component 7a and a position of an end portion on the upper side of the second electronic component 7b can be set to be substantially the same. Thus, according to the present embodiment, it is possible to suppress the inverter housing portion 84 from becoming large in the circumferential direction. Therefore, it is possible to suppress the increase in the projection area of the drive apparatus 1 in the axial direction, and it is possible to downsize the entire drive apparatus 1.

In addition, the second electronic component 7b is disposed on the upper side of the output axis J3 and the pump 8. That is, the second electronic component 7b, the output axis J3, and the pump 8 are disposed in the circumferential direction. In the present embodiment, the second electronic component 7b, the output axis J3, and the pump 8 are disposed in the vertical direction. A position of an end portion on the upper side of the output shaft 55 is located on the lower side with respect to a position of an end portion on the upper side of the motor housing portion 81. A position of an end portion on the lower side of the output shaft 55 is located on the upper side with respect to a position of an end portion on the lower side of the motor housing portion 81. Thus, according to the present embodiment, the inverter 7, the output shaft 55, and the pump 8 can be compactly disposed in the vertical direction by disposing the second electronic component 7b having a large dimension in the vertical direction on the upper side of the output shaft 55 and disposing the pump 8 on the lower side of the output shaft 55. As a result, it is possible to suppress an increase in a projection area of the drive apparatus 1 in the radial direction and the axial direction, and it is possible to downsize the entire drive apparatus 1.

Note that, in the present embodiment, it has been described that one first electronic component 7a is disposed in the first region 64d and one second electronic component 7b is disposed in the second region 64e. However, in addition to the first electronic component 7a, another electronic component having a smaller dimension in the circumferential direction than the first electronic component may be disposed in the first region 64d. Similarly, in addition to the second electronic component 7b, another electronic component having a smaller dimension in the circumferential direction than the second electronic component 7b may be disposed in the second region 64e. That is, the first electronic component 7a may be a component having a largest dimension in the circumferential direction (dimension in the vertical direction in the present embodiment) among the electronic components provided in the first region 64d. Similarly, the second electronic component may be a component having a largest dimension in the circumferential direction (dimension in the vertical direction in the present embodiment) among the electronic components provided in the second region 64e.

As illustrated in FIG. 1, a refrigerant flow path 70 is provided in the housing 6. The refrigerant flow path 70 is formed across the motor housing portion 81, the support portion 83, and the inverter housing portion 84. The refrigerant flow path 70 is a route through which the refrigerant L cooled by a radiator (not illustrated) flows. The refrigerant L flows from the radiator to the radiator again via the inverter housing portion 84, the motor housing portion 81, the support portion 83, and the cooler 9. That is, the drive apparatus 1 includes the refrigerant flow path 70 through which the refrigerant L flows. The refrigerant L flowing through the refrigerant flow path 70 cools the inverter 7 in the inverter housing portion 84. In addition, as described above, the refrigerant L flowing through the refrigerant flow path 70 exchanges heat with the oil O inside the cooler 9 to cool the oil O. Note that, in the present embodiment, the refrigerant L is water.

The refrigerant flow path 70 includes an intra-inverter housing portion refrigerant flow path 71, a first refrigerant flow path 72, a connection refrigerant flow path 73, the intra-cooler refrigerant flow path 74, an outflow side refrigerant flow path 75, a pipe (not illustrated), and an external pipe 69. In the present embodiment, the intra-inverter housing portion refrigerant flow path 71, the first refrigerant flow path 72, the connection refrigerant flow path 73, and the outflow side refrigerant flow path 75 are provided inside the wall portion of the housing 6. Therefore, it is not necessary to separately prepare a pipe material in order to provide these flow paths, and a decrease in the number of components can be achieved.

As illustrated in FIG. 1, the intra-inverter housing portion refrigerant flow path 71 is connected to a pipe (not illustrated) and the first refrigerant flow path 72. The refrigerant L flowing through the intra-inverter housing portion refrigerant flow path 71 passes through the inside of the inverter cover 64. That is, the refrigerant L flowing through the intra-inverter housing portion refrigerant flow path 71 passes through the inverter housing portion 84. As a result, the refrigerant L flowing through the intra-inverter housing portion refrigerant flow path 71 cools the inverter 7 via the inverter cover 64. The intra-inverter housing portion refrigerant flow path 71 extends to one side in the axial direction. As illustrated in FIG. 2, an opening 64f is provided at one end of the intra-inverter housing portion refrigerant flow path 71. A pipe (not illustrated) is connected to the opening 64f. The intra-inverter housing portion refrigerant flow path 71 is connected to a radiator (not illustrated) via a pipe. As a result, the refrigerant L cooled by the radiator is supplied to the intra-inverter housing portion refrigerant flow path 71.

As illustrated in FIG. 1, the first refrigerant flow path 72 is connected to the intra-inverter housing portion refrigerant flow path 71 and the connection refrigerant flow path 73. The refrigerant L flowing through the first refrigerant flow path 72 passes through the inside of the inverter housing portion 84 and the support portion 83. The first refrigerant flow path 72 extends substantially in the vertical direction.

The connection refrigerant flow path 73 is connected to the first refrigerant flow path 72 and the intra-cooler refrigerant flow path 74. The refrigerant L flowing through the connection refrigerant flow path 73 passes through the inside of the support portion 83. One end of the connection refrigerant flow path 73 is connected to the refrigerant inflow port 9c of the cooler 9. As a result, the connection refrigerant flow path 73 and the intra-cooler refrigerant flow path 74 are connected. The connection refrigerant flow path 73 extends toward the vehicle rear side (+X direction side) inside the support portion 83. In the present embodiment, the connection refrigerant flow path 73 extends linearly. The connection refrigerant flow path 73 and the connection flow path 92a extend in parallel within the wall of the housing 6. That is, the connection refrigerant flow path 73 and the connection flow path 92a extending inside the support portion 83 of the housing 6 are parallel to each other and extend in the same direction. Thus, according to the present embodiment, for example, when the connection refrigerant flow path 73 and the connection flow path 92a are provided in the housing 6 by machining such as drilling, after one of the connection refrigerant flow path 73 and the connection flow path 92a is provided, the other thereof can be provided by being moved in parallel without changing a posture of a drill. Therefore, it is possible to suppress an increase in the number of processing steps of the housing 6. That is, it is possible to suppress the number of manufacturing steps of the drive apparatus 1.

The intra-cooler refrigerant flow path 74 is connected to the connection refrigerant flow path 73 and the outflow side refrigerant flow path 75. The intra-cooler refrigerant flow path 74 is provided within the cooler 9. That is, the intra-cooler refrigerant flow path 74 through which the refrigerant L passes is provided within the cooler 9. As illustrated in FIGS. 1 and 4, the intra-cooler refrigerant flow path 74 and the connection refrigerant flow path 73 are connected via the refrigerant inflow port 9c of the cooler 9. The intra-cooler refrigerant flow path 74 and the outflow side refrigerant flow path 75 are connected via the refrigerant outflow port 9d of the cooler 9. The intra-cooler refrigerant flow path 74 is connected to the refrigerant inflow port 9c and the refrigerant outflow port 9d. That is, the cooler 9 has the refrigerant inflow port 9c into which the refrigerant L flows and the refrigerant outflow port 9d from which the refrigerant L flows out. As illustrated in FIG. 3, the intra-cooler refrigerant flow path 74 extends in the circumferential direction of the output axis J3 when viewed in the axial direction. In addition, as described above, the intra-cooler flow path 91c extends in the circumferential direction of the output axis J3 when viewed in the axial direction. The intra-cooler refrigerant flow path 74 is disposed to overlap the intra-cooler flow path 91c and the output axis J3 in the radial direction of the motor axis J1. Thus, according to the present embodiment, the intra-cooler flow path 91c, the intra-cooler refrigerant flow path 74, and the output shaft 55 hardly interfere with each other, and the cooler 9 can be disposed close to the output shaft 55. Thus, the cooler 9 can be disposed close to the output shaft 55 in the radial direction. Therefore, it is possible to downsize the entire drive apparatus 1 in the radial direction.

In addition, as illustrated in FIG. 4, the refrigerant inflow port 9c is located on the upper side with respect to the output axis J3. The refrigerant outflow port 9d is located on the lower side with respect to the output axis J3. The output axis J3 is disposed between the refrigerant inflow port 9c and the refrigerant outflow port 9d in the vertical direction. That is, the output axis J3 is disposed between the refrigerant inflow port 9c and the refrigerant outflow port 9d in the circumferential direction. Thus, according to the present embodiment, the cooler 9 is disposed radially outside with respect to the output shaft 55. Thus, a position of an end portion on the lower side of the cooler 9 can be disposed on the upper side with respect to a position of an end portion of the lower side of the motor housing portion 81 and a position of an end portion on the lower side of the transmission mechanism housing portion 82. Therefore, it is possible to downsize the drive apparatus 1 in the vertical direction.

As illustrated in FIG. 1, the outflow side refrigerant flow path 75 is connected to the intra-cooler refrigerant flow path 74 and the external pipe 69. The outflow side refrigerant flow path 75 is a flow path extending in the axial direction through the support portion 83. In the present embodiment, the outflow side refrigerant flow path 75 is linear. That is, the refrigerant flow path 70 has the outflow side refrigerant flow path 75 extending from the refrigerant outflow port 9d on the inside of the wall of the housing 6. An opening 75a is provided at one end of the outflow side refrigerant flow path 75. One end of the external pipe 69 is connected to the opening 75a. The other end of the external pipe 69 is connected to a radiator (not illustrated). As shown in FIG. 4, a direction which the opening 75a of the outflow side refrigerant flow path 75 faces is parallel to the output axis J3. Thus, according to the present embodiment, as illustrated in FIG. 2, when the external pipe 69 is attached to the drive apparatus 1, the external pipe 69 can be connected to the opening 75a from the other side in the axial direction while the output shaft 55 is easily avoided. Therefore, a work of attaching the external pipe 69 to the drive apparatus 1 can be simplified. In addition, according to the present embodiment, the opening 75a is provided on the vehicle rear side (+X direction side) with respect to the output shaft 55 and the pump 8. Thus, a position of the opening 75a can be easily visually recognized from the outside of the drive apparatus 1, and the work of attaching the external pipe 69 to the drive apparatus 1 can be further simplified.

According to the present embodiment, the housing 6 includes the motor housing portion 81, the transmission mechanism housing portion 82 located on one side of the motor housing portion 81 in the axial direction, the inverter housing portion 84, and the support portion 83 located radially outside the motor housing portion 81 and on one side of the inverter housing portion 84 in the circumferential direction when viewed from the axial direction and connected to the outer peripheral portion of the motor housing portion 81 and the bottom portion of the inverter housing portion 84. Thus, the support portion 83 can be provided in the above-described dead space formed between the motor housing portion 81, the transmission mechanism housing portion 82, and the inverter housing portion 84. In addition, the support portion 83 supports the pump 8 and the cooler 9, one of the pump 8 and the cooler 9 is disposed on one side in the circumferential direction with respect to the support portion 83 when viewed from the axial direction, and the other thereof is disposed radially outside with respect to the support portion 83. Thus, the pump 8 and the cooler 9 can be provided in the dead space. Therefore, the entire drive apparatus 1 can be downsized.

In addition, in the present embodiment, the support portion 83 is connected to the outer peripheral portion of the motor housing portion 81, and the pump 8 and the cooler 9 are supported by the support portion 83. Thus, the oil passage 90 connected to the motor housing portion 81, the pump 8, and the cooler 9 via the support portion 83 can be shortened. Therefore, a pressure loss in the oil passage 90 can be reduced, and efficient circulation of the oil O can be realized when the drive apparatus 1 is driven. In addition, the support portion 83 is connected to the outer peripheral portion of the motor housing portion 81 and the bottom portion of the inverter housing portion 84, and the cooler 9 is supported by the support portion 83. Thus, the refrigerant flow path 70 connected to the motor housing portion 81, the inverter housing portion 84, and the cooler 9 via the support portion 83 can be shortened. Therefore, a pressure loss in the refrigerant flow path 70 can be reduced, and efficient circulation of the refrigerant L can be realized when the drive apparatus 1 is driven.

Furthermore, in the present embodiment, as described above, one of the pump 8 and the cooler 9 is disposed on one side in the circumferential direction with respect to the support portion 83 when viewed from the axial direction, and the other thereof is disposed radially outside with respect to the support portion 83. That is, the pump 8 and the cooler 9 are disposed in different directions from each other with respect to the support portion 83. Thus, in the present embodiment, an oil passage connected to the pump 8, oil passages connected to the pump 8 and the cooler 9, and a cooling flow path connected to the cooler 9, which are provided inside the support portion 83, can be easily and linearly provided. More specifically, in the present embodiment, the first flow path 91a, the second flow path 91b, the connection flow path 92a, the connection refrigerant flow path 73, and the outflow side refrigerant flow path 75 are linearly provided. Thus, pressure losses in the oil passage 90 and the refrigerant flow path 70 can be further reduced, and more efficient circulation of the oil O and the refrigerant L can be realized.

According to the present embodiment, the support portion 83 is located on the other side of the transmission mechanism housing portion 82 in the axial direction and is connected to the transmission mechanism housing portion 82. That is, the support portion 83 is connected to the motor housing portion 81 and the transmission mechanism housing portion 82. Thus, it is possible to shorten the oil passage 90 connected to the motor housing portion 81, the transmission mechanism housing portion 82, the pump 8, and the cooler 9 via the support portion 83. Therefore, the pressure loss in the oil passage 90 can be reduced, and efficient circulation of the oil O can be realized.

According to the present embodiment, the pump 8 is disposed on one side in the circumferential direction with respect to the support portion 83 when viewed from the axial direction. In the present embodiment, the pump 8 is disposed on the lower side of the support portion 83. The cooler 9 is disposed radially outside with respect to the support portion 83 when viewed from the axial direction. In the present embodiment, the cooler 9 is disposed on the vehicle rear side (+X direction side) of the support portion 83. That is, the pump 8 and the cooler 9 are disposed in different directions from each other with respect to the support portion 83. Thus, the support portion 83, the pump 8, and the cooler 9 can be compactly disposed, and the support portion 83, the pump 8, and the cooler 9 can be disposed in the dead space. Therefore, the entire drive apparatus 1 can be downsized.

In addition, in the present embodiment, the pump 8 can be disposed near the oil pool P located in the lower region of the transmission mechanism housing portion 82. Thus, the first flow path 91a connected to the oil pool P and the pump 8 can be shortened. In addition, the first flow path 91a can be, for example, a linear flow path. Thus, a pressure loss in the first flow path 91a can be reduced, and efficient circulation of the oil O can be realized. In addition, according to the present embodiment, the suction port 8c of the pump 8 is located on one side in the axial direction. Thus, the suction port 8c can be disposed near the oil pool P, and the first flow path 91a connected to the oil pool P and the suction port 8c can be shortened. Thus, a pressure loss in the route from the oil pool P to the pump 8 can be further reduced, and more efficient circulation of the oil O can be realized.

According to the present embodiment, the transmission mechanism 3 includes the output shaft 55 amount the output axis J3 parallel to the motor axis J1, and the output shaft 55 penetrates the support portion 83. That is, in the dead space, the support portion 83 is provided to surround the periphery of the output shaft 55. Thus, the support portion 83 can be connected to the motor housing portion 81, the transmission mechanism housing portion 82, and the inverter housing portion 84. Thus, the oil passage 90 provided across the support portion 83, the motor housing portion 81, and the transmission mechanism housing portion 82 can be shortened. In addition, the refrigerant flow path 70 provided across the support portion 83, the motor housing portion 81, and the inverter housing portion 84 can be shortened. Therefore, the pressure losses in the oil passage 90 and the refrigerant flow path 70 can be further reduced, and more efficient circulation of the oil O and the refrigerant L can be realized.

Note that the pump and the cooler may be disposed in any manner as long as the pump and the cooler can be disposed in the dead space. For example, the pump may be disposed radially outside the support portion, and the cooler may be disposed on one side of the support portion in the circumferential direction. In addition, both the pump and the cooler may be disposed on one side of the support portion in the circumferential direction, or may be disposed radially outside the support portion.

The pump may not be an electric pump as long as oil can be pumped to the oil passage. For example, a mechanical pump may be used. In this case, a pump drive unit is connected to the output shaft via a coupling mechanism such as a gear, and the pump can be driven by using the rotation of the output shaft.

The flow path is not limited to the configuration of the present embodiment as long as the motor can be cooled. For example, any one of the third flow path, the fifth flow path, and the second intra-shaft flow path may not be provided. In addition, a separate flow path for supplying a fluid to the motor may be added. In addition, the refrigerant flow path is not limited to the configuration of the present embodiment as long as the refrigerant flow path can cool the inverter and the fluid. Two or more pumps and coolers may be provided.

Although the embodiment of the present invention has been described above, the respective configurations in the embodiment and combinations thereof are merely examples, and addition, omission, substitution, and other alterations may be appropriately made within a range not departing from the gist of the present invention. In addition, the present invention is not limited by the embodiment.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a motor that includes a rotor rotating about a motor axis and a stator surrounding the rotor;
a transmission mechanism that includes a plurality of gears and transmits a power of the motor;
an inverter that controls a current to be supplied to the motor;
a housing that houses the motor, the transmission mechanism, and the inverter;
a fluid that is housed within the housing;
a flow path through which the fluid flows;
a refrigerant that cools at least the inverter;
a refrigerant flow path through which the refrigerant flows;
a pump that pumps the fluid within the flow path; and
a cooler that exchanges heat between the fluid and the refrigerant,
wherein the housing includes
a motor housing portion that houses the motor,
a transmission mechanism housing portion that is located on one side of the motor housing portion in an axial direction to house the transmission mechanism,
an inverter housing portion that houses the inverter, and
a support portion that is located radially outside the motor housing portion and one side of the inverter housing portion in a circumferential direction when viewed from the axial direction, and is connected to an outer peripheral portion of the motor housing portion and a bottom portion of the inverter housing portion,
the support portion supports the pump and the cooler, and
any one of the pump and the cooler is disposed on one side in the circumferential direction with respect to the support portion when viewed from the axial direction, and the other thereof is disposed radially outside with respect to the support portion.

2. The drive apparatus according to claim 1, wherein the support portion is located on the other side of the transmission mechanism housing portion in the axial direction, and is connected to the transmission mechanism housing portion.

3. The drive apparatus according to claim 1,
wherein the pump is disposed on one side in the circumferential direction with respect to the support portion when viewed from the axial direction, and
the cooler is disposed radially outside with respect to the support portion.

4. The drive apparatus according to claim 1,
wherein the transmission mechanism includes an output shaft about an output axis parallel to the motor axis, and
the output shaft penetrates the support portion.

5. The drive apparatus according to claim 4,
wherein the cooler includes a refrigerant inflow port into which the refrigerant flows and a refrigerant outflow port from which the refrigerant flows, and
in the circumferential direction, the output axis is disposed between the refrigerant inflow port and the refrigerant outflow port.

6. The drive apparatus according to claim 5,
wherein an intra-cooler flow path through which the fluid passes and an intra-cooler refrigerant flow path through which the refrigerant passes are provided within the cooler,
the intra-cooler flow path, the intra-cooler refrigerant flow path, and the output axis are disposed to overlap in the radial direction of the motor axis, and
the intra-cooler flow path and the intra-cooler refrigerant flow path extend in the circumferential direction of the output axis when viewed in the axial direction.

7. The drive apparatus according to claim 5,
wherein the refrigerant flow path includes
an outflow side refrigerant flow path that extends from the refrigerant outflow port and is provided on an inside of a wall of the housing, and
an external pipe that is connected to an opening of the outflow side refrigerant flow path, and
a direction which the opening of the outflow side refrigerant flow path faces is parallel to the output axis.

8. The drive apparatus according to claim 4,
wherein the inverter housing portion includes, when viewed from the axial direction,
a first region that is located radially outside the motor housing portion, and
a second region that is located between the first region and the other side of the support portion in the circumferential direction in the circumferential direction,
the bottom portion of the inverter housing portion is inclined to one side in the circumferential direction from the first region toward the second region,
in the inverter, a first electronic component is disposed in the first region,
a second electronic component is disposed in the second region, and
the second electronic component has a larger dimension in the circumferential direction than the first electronic component.

9. The drive apparatus according to claim 8, wherein the second electronic component, the output axis, and the pump are disposed in the circumferential direction.

10. The drive apparatus according to claim 1,
wherein the refrigerant flow path includes
an intra-inverter housing portion refrigerant flow path that is provided in the inverter housing portion to cool the inverter, and
a connection refrigerant flow path that connects the intra-inverter housing portion refrigerant flow path and the cooler,
the flow path includes
an intra-motor housing portion flow path that is provided in the motor housing portion, and
a connection flow path that connects the intra-motor housing portion flow path and the cooler, and
the connection refrigerant flow path and the connection flow path extend in parallel with an inside of the wall of the housing.

11. The drive apparatus according to claim 1,
wherein the pump includes a pump motor that rotates about a rotation axis parallel to the motor axis, and
the rotation axis is located on one side in the circumferential direction with respect to axes of a plurality of shafts of the motor and the transmission mechanism.

12. The drive apparatus according to claim 1, wherein positions of end portions on one side of the pump and the cooler in the circumferential direction are located on the other side in the circumferential direction with respect to positions of end portions on one side of the motor housing portion and the transmission mechanism housing portion in the circumferential direction.

13. The drive apparatus according to claim 1, wherein the pump and the cooler overlap the inverter housing portion in the circumferential direction.
